(19) United States
(12) Patent Application Publication
(10) Pub. No.: US 2017/0103241 A1
(43) Pub. Date: Apr. 13, 2017

(54) MOTOR DRIVE HAVING RF TAG

(71) Applicant: FANUC CORPORATION, Yamanashi (JP)

(72) Inventor: Yuuichi Yamada, Yamanashi (JP)

(73) Assignee: FANUC CORPORATION, Yamanashi (JP)

(21) Appl. No.: 15/284,598

(22) Filed: Oct. 4, 2016

(30) Foreign Application Priority Data
Oct. 7, 2015 (JP) 2015-199505

(51) Int. Cl. G06K 7/10

(52) U.S. Cl. CPC G06K 7/10366

(57) ABSTRACT

A motor drive according to an embodiment of the present invention, which is a motor drive for driving a motor, includes a detection circuit for detecting the state of the inside of the motor drive; a first memory and a second memory for storing information including a detection value indicating the state detected by the detection circuit; an RF tag having the first memory; an interface circuit for transmitting and receiving information to and from external equipment; and a controller for transmitting at least a part of the information stored in the second memory to the outside through the RF tag or the interface circuit.

This application is a new U.S. patent application that claims benefit of JP 2015-199505 filed on Oct. 7, 2015, the content of 2015-199505 is incorporated herein by reference.

### BACKGROUND OF THE INVENTION

1. Field of the Invention

The present invention relates to a motor drive, and in particular relates to a motor drive having an RF tag.

2. Description of Related Art

Motor drives having an RF (Radio Frequency) tag inside the drive are conventionally known (for example, Japanese Unexamined Patent Publication (Kokai) No. 2006-174614, hereinafter referred to as “patent document 1”). The RF tag is an electronic device that can transmit information of an internal memory to external equipment by radio communication without requiring power supply from the motor drive.

Patent document 1 describes a motor drive that has the function of transmitting management information (overall information about the motor drive including alarm information) stored in an RF tag to external equipment, in a state of shutting down a power supply to the motor drive and an absence of power to a control circuit.

FIG. 1 shows the structure of a conventional inverter unit for controlling the drive of a motor. An

RF tag (IC tag) 1002 is fixed in an inverter unit 1001. The inverter unit 1001 transmits drive power and management information to the RF tag 1002 through wires. An R/W (read/write) unit 1003 reads the management information from the RF tag 1002. An inverter case 1011 contains a main circuit.

In the conventional art, in the event that the information stored in the RF tag is lost due to any abnormality, the information cannot be read out. Moreover, the amount of storable information is limited to the storage capacity of the RF tag.

### SUMMARY OF THE INVENTION

The present invention aims at providing a motor drive that can transmit information stored in a first memory provided in an RF tag to external equipment when a motor drive is powered off, as well as transmit a larger amount of information stored in a second memory, which is separated from the RF tag, to external equipment when the motor drive is powered on.

A motor drive according to an embodiment of the present invention, which is a motor drive for driving a motor, includes a detection circuit for detecting the state of the inside of the motor drive; a first memory and a second memory for storing information including a detection value indicating the state detected by the detection circuit; an RF tag having the first memory; an interface circuit for transmitting and receiving information to and from external equipment; and a controller for transmitting at least a part of the information stored in the second memory to the outside through the RF tag or the interface circuit.

### BRIEF DESCRIPTION OF THE DRAWINGS

The objects, features, and advantages of the present invention will be more apparent from the following description of embodiments in conjunction with the attached drawings, wherein:

FIG. 1 is a perspective view of a conventional motor drive;

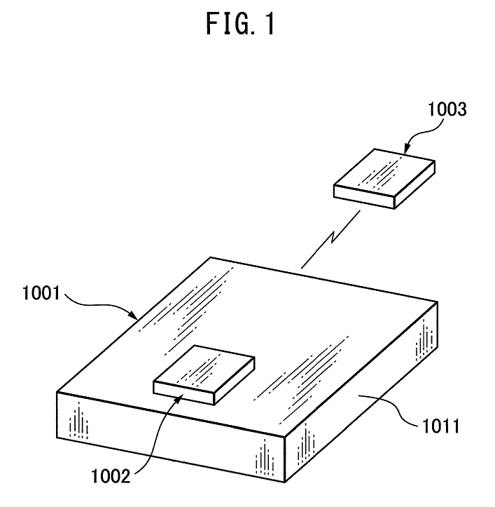

FIG. 2 is a block diagram of a motor drive according to a first embodiment of the present invention;

FIG. 3 is a flowchart of the operation of the motor drive according to the first embodiment of the present invention; and

FIG. 4 is a block diagram of a motor drive according to a second embodiment of the present invention.

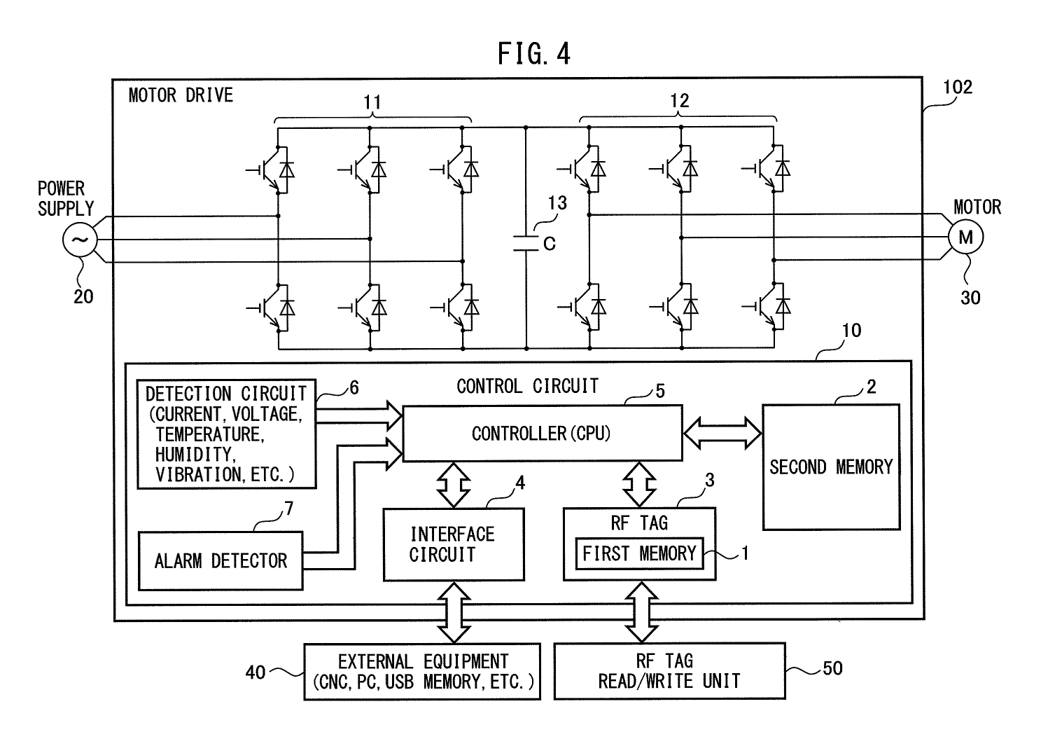

### DETAILED DESCRIPTION OF THE INVENTION

A motor drive according to the present invention will be described below with reference to the drawings.

### First Embodiment

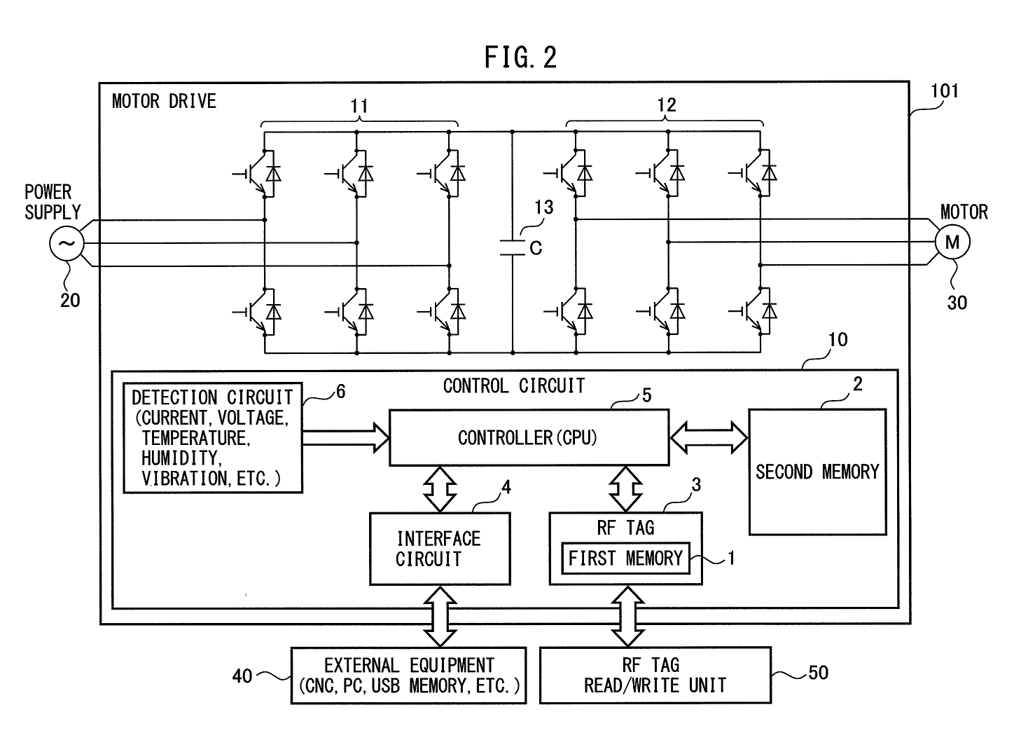

A motor drive according to a first embodiment of the present invention will be described. FIG. 2 is a block diagram of the motor drive according to the first embodiment of the present invention. A motor drive 101 according to the first embodiment of the present invention is a motor drive for driving a motor 30. The motor drive 101 includes a detection circuit 6, a first memory 1, a second memory 2, an RF tag 3, an interface circuit 4, and a controller 5.

The motor drive 101 has a converter 11 for converting an AC power inputted from a power supply 20 into a DC power, a capacitor 13 for smoothing the converted DC power, and an inverter 12 for converting the smoothed DC power into an AC power to drive the motor 30. A control circuit 10 controls the converter 11 and the inverter 12. FIG. 2 shows a structure for driving a three-phase motor, and each of the converter 11 and the inverter 12 has six pairs of transistors and diodes.

The control circuit 10 includes the first memory 1, the second memory 2, the RF tag 3, the interface circuit 4, the controller 5, and the detection circuit 6.

The detection circuit 6 detects the state of the inside of the motor drive 101. The state of the inside of the motor drive 101 includes at least one of current, voltage, temperature, humidity, vibration, and the like detected inside the motor drive 101. Thus, the detection circuit 6 is a generic name for various detection circuits including a voltage detector, a current detector, a temperature sensor, a humidity sensor, a vibration sensor, and the like. Values detected by the detection circuit 6 are transmitted to the controller 5, which is constituted of, for example, a CPU.

The first memory 1 and the second memory 2 store information including the detection values indicating the state detected by the detection circuit 6. The second memory 2 stores the information stored in the first memory 1 in part or in entirety. Furthermore, the second memory 2 can store information that is not stored in the first memory 1.

The RF tag 3 has the first memory 1. The RF tag 3 can transmit and receive information to and from an RF tag read/write unit 50 provided outside the motor drive 101. The RF tag 3 transmits information stored in the first memory 1 to the RF tag read/write unit 50, and stores information received through the RF tag read/write unit 50 in the first memory 1. Furthermore, the RF tag 3 can transmit and receive information to and from the second memory 2 through the controller 5, and moreover can transmit and receive the information to and from the RF tag read/write unit 50. However, the first memory 1 is smaller than the second memory 2 in capacity. Thus, in the case of transmitting and receiving a larger amount of information than the capacity of the first memory 1, the information is preferably transmitted to and received from the outside through the interface circuit 4.

The interface circuit 4 transmits and receives information to and from external equipment 40. As an example of the external equipment 40, there is a computer numerical controller (CNC), a personal computer (PC), a USB memory, or the like, but the external equipment 40 is not limited thereto. The interface circuit 4 can transmit and receive information to and from the second memory 2 through the controller 5, and can transmit and receive the information to and from the external equipment 40. This configuration allows the interface circuit 4 to read out the information stored in the second memory 2, when the motor drive 101 and the control circuit 10 are supplied with power, even if the information stored in the RF tag 3 cannot be read out owing to any abnormality.

The controller 5 transmits at least a part of the information stored in the second memory 2 to the outside through the RF tag 3 or the interface circuit 4.

According to the configuration described above, especially when the motor drive 101 is returned to a repair department by itself due to the occurrence of a malfunction, the obtainment of more information serves to reduce man-hours for repair.

To store the entire management information in the first memory 1 provided in the RF tag 3, the RF tag 3 is required to have a mass storage memory so as to store the entire management information and a power supply circuit for driving the mass storage memory, and therefore the RF tag becomes expensive. Thus, the second memory 2 preferably stores information the amount of which exceeds the capacity of the first memory 1 provided in the RF tag 3.

According to the motor drive of the first embodiment of the present invention, the repair department can obtain the management information of the broken motor drive as electronic data, thus bringing efficiency to reception operation in the repair department.

On the occasion of a repair, a repair history is written to the first memory 1 of the RF tag 3 provided in the motor drive or the second memory 2, which is separated from the RF tag 3, provided in the motor drive. Thus, when another malfunction occurs after the repair and another repair is required again, the efficiency of a repair operation is expected to be improved by referring to the last repair history.

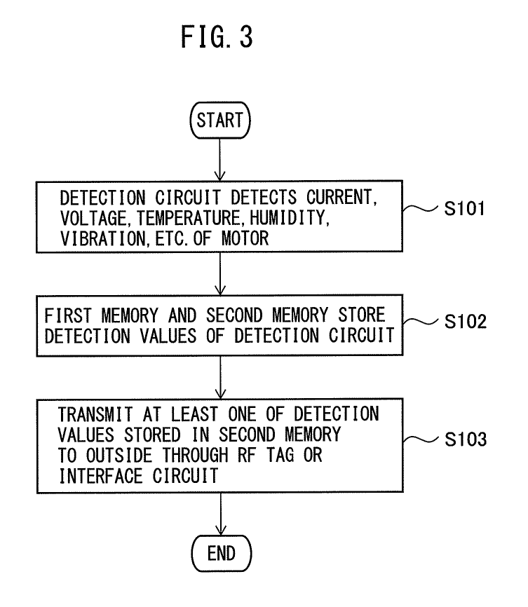

Next, the operation of the motor drive according to the first embodiment of the present invention will be described with reference to a flowchart shown in FIG. 3. First, at step S101, the detection circuit 6 detects the current, voltage, temperature, humidity, vibration, and the like of the motor 30. Values detected by the detection circuit 6 are outputted to the controller 5.

Next, at step S102, the first memory 1 and the second memory 2 obtain and store the detection values of the detection circuit 6.

Next, at step S103, the controller 5 transmits at least one of the detection values stored in the second memory 2 to the outside through the RF tag 3 or the interface circuit 4. To be more specific, the controller 5 outputs at least one of the detection values stored in the second memory 2 to the RF tag read/write unit 50 through the RF tag 3, or outputs at least one of the detection values stored in the second memory 2 to the external equipment 40 through the interface circuit 4.

As described above, according to the motor drive of the first embodiment of the present invention, it is possible to transmit a larger amount of information stored in the second memory 2, which is separated from the RF tag 3, to external equipment when the motor drive is powered on, as well as transmit information stored in the first memory 1 provided in the RF tag 3 to external equipment when the motor drive is powered off.

### Second Embodiment

Next, a motor drive according to a second embodiment of the present invention will be described. The difference between a motor drive 102 according to the second embodiment of the present invention and the motor drive 101 according to the first embodiment is that the motor drive 102 further includes an alarm detector 7 for detecting an alarm issued within the motor drive 102, and at least a part of the following information is written in the first memory 1 and the second memory 2:

Alarm history (the date of issue, the type of an alarm);

Type of the motor drive;

Version of the motor drive;

Production identification code of the motor drive (the date of manufacture, lot number); and

Repair history of the motor drive.

The other configurations of the motor drive 102 according to the second embodiment are the same as those of the motor drive 101 according to the first embodiment, so a detailed description thereof will be omitted.

When an abnormality has occurred in the motor drive 102, the alarm detector 7 detects the abnormality in the form of an alarm having occurred in the motor drive 102. The alarm detector 7 is compliant with information detected by the detection circuit 6. For example, when the detection circuit 6 detects the current, voltage, temperature, humidity, and vibration of the motor drive 102, the alarm detector 7 has the function of detecting that each value of the current, voltage, temperature, humidity, and vibration has gone out of its predetermined range.

The management information of the motor drive includes the following items.

### (1) Alarm History

The alarm history includes the date of issue of an alarm and the type of the alarm.

### (2) Type of the Motor Drive

The type of the motor drive includes the model number of motor drive.

### (3) Version of the Motor Drive

The version of the motor drive is the so-called version number of the motor drive.

### (4) Production Identification Code of the Motor Drive

The production identification code of the motor drive includes the date of manufacture of the motor drive and the lot number of the motor drive.

### (5) Repair History of the Motor Drive

The repair history of the motor drive includes the date of repair of the motor drive, details of the repair, and the like.

However, the above is merely an example, and the management information is not limited thereto. In addition to the above information, information (current, voltage, temperature, humidity, vibration, and the like) detected within the motor drive may be included.

According to the motor drive of the second embodiment of the present invention, since an alarm issued within the motor drive is detected and information about the alarm is stored, repair is easily made on the motor drive after an alarm is issued. Furthermore, by retrieving a repair method from a database, which stores repair methods while being associated with the types of alarms, based on the management information, the efficiency of a repair is improved.

According to the motor drive of the embodiments of the present invention, it is possible to provide a motor drive that can transmit a larger amount of information stored in the second memory, which is separated from the RF tag, to external equipment when the motor drive is powered on, as well as transmit information stored in the first memory provided in the RF tag to external equipment when the motor drive is powered off.

What is claimed is:

1. A motor drive for driving a motor comprising:
a detection circuit for detecting the state of the inside of the motor drive;
a first memory and a second memory for storing information including a detection value indicating the state detected by the detection circuit;
an RF tag having the first memory;
an interface circuit for transmitting and receiving information to and from external equipment; and
a controller for transmitting at least a part of the information stored in the second memory to the outside through the RF tag or the interface circuit.

2. The motor drive according to claim 1, wherein
the first memory and the second memory can receive arbitrary information from the outside of the motor drive; and
the second memory receives the information through the RF tag or the interface circuit.

3. The motor drive according to claim 1, further comprising:
an alarm detector for detecting an alarm issued within the motor drive, wherein
the first memory and the second memory store at least a part of the following information:
an alarm history including the date of issue of the alarm and the type of the alarm;
the type of the motor drive;
the version of the motor drive;
a production identification code of the motor drive including the date of manufacture and a lot number; and
a repair history of the motor drive.
